(19) United States
(12) Patent Application Publication
(10) Pub. No.: US 2003/0227614 A1
(43) Pub. Date: Dec. 11, 2003

(54) Laser machining apparatus with automatic focusing

(76) Inventors: August A. Taminiau, GN Koudekerk a/d Rijn (NL); Marco Bak, AK 's -Gravenzande (NL)

Correspondence Address: STALLMAN & POLLOCK LLP, Suite 290, 121 Spear Street, San Francisco, CA, 94105, US

(21) Appl. No.: 10/163,126

(22) Filed: Jun. 5, 2002

(51) Int. Cl. G01B 9/00

(52) U.S. Cl. 356/125

(57) ABSTRACT

In laser machining a feature of a predetermined depth in an object, laser radiation is directed onto the object by an apparatus including an optical system. The optical system includes a movable lens element for varying the focal length of the optical system. Laser radiation reflected from the object is collected by the optical system and used to by the apparatus determine whether or not the laser radiation is focused on the object. The laser radiation is initially focused on the object. As the feature depth increases during machining the movable lens element is incrementally moved by the apparatus to refocus the laser radiation on the base of the feature. The instant depth of the feature is determined by the apparatus from the lens motion and compared with the predetermined depth. The apparatus terminates the machining operation when the instant depth determined from the lens motion is about equal to the predetermined depth.

### TECHNICAL FIELD OF THE INVENTION

The present invention relates generally to a laser machining or engraving apparatus. The invention relates in particular to a laser machining apparatus including an autofocus arrangement for maintaining a laser beam focused on the base of a feature being machined as the depth of the feature changes during the machining.

### DISCUSSION OF BACKGROUND ART

Lasers are being increasingly used for precise operations in laser marking and laser machining. In such operations, laser radiation is usually focused into a focal spot on the surface of a material being marked or machined and delivered as in a sequence of pulses. The amount of material removed is dependent, among other factors, on the power intensity of the laser radiation in the focal spot and the number of pulses delivered.

Several problems may be encountered in performing such laser machining operations. By way of example, one problem frequently encountered, particularly in machining relatively deep features in a material, is that as soon as material being machined is removed by the action of optimally focused radiation, the base of the feature being machined will no longer be in the plane of optimal focus. Accordingly, the power intensity of the machining beam at the instantaneous plane of machining will decrease with increasing depth of machining. This can lead to problems in controlling the depth and size of machined features.

A problem could also be experienced in attempting to machine a plurality of identical-sized features on a non-plane surface. Such a non-plane surface may be a surface that is intentionally contoured, or a surface that is nominally plane but has spatial variations from perfect planarity comparable to or greater than the depth of focus or the Rayleigh range of the focused laser radiation.

Another problem in laser machining a feature in a material is not knowing how deep the feature is at any instant during the machining. In machining such features, it can be important to stop machining at a precise depth. Prior art machining methods rely on controlling the reproducibility of laser power from pulse to pulse in a sequence of pulses and from one sequence of pulses to the next, and relying on delivering a predetermined number of pulses to machine a feature of a desired depth. Significant progress has been made in controlling such pulse sequences, however, this approach still presents certain problems. One such problem is that the rate of removal of material may vary with depth of a feature being machined. This variation can be expected to be different from material to material. This can lead to a need for extensive calibration efforts being required for each different operation in each different material to be machined.

There is a need for laser machining apparatus that provides a solution to one or more of the above-discussed problems. Preferably, the apparatus should at least be capable of monitoring the depth of a feature being machined.

### SUMMARY OF THE INVENTION

In one aspect, the present invention is directed to method of laser machining a plurality of features in an object. The method is carried out using apparatus including a laser for providing laser radiation and an optical system for delivering the laser radiation to the object. Power of the laser radiation is adjustable into first and second ranges. A power in the first power range is insufficient to remove material from the object. A power in the second power range is sufficient to remove material from the object. The optical system has a selectively variable focal length. The optical system is arranged to receive a portion of the laser beam delivered to the object that is reflected from the object. The optical system includes a detector arrangement for determining from the reflected portion of the laser radiation whether or not the laser radiation is focused on the object.

In one preferred embodiment of the method, the power of the laser radiation is adjusted to the first range. The first-power-range laser radiation is delivered by the optical system to a first location on the object. The detector arrangement determines whether or not the first-power-range laser radiation is focused on the object. If the detector arrangement determines that the first-power-range laser radiation is not focused on the object, the focal length of the optical system is varied until the detector arrangement determines that the first-power-range radiation is focused on the object. After the detector arrangement determines that the first-power-range laser radiation is focused on the object, the power of the laser radiation is adjusted to the second power range and material is removed from the object using the second-power-range laser radiation until a feature is machined in the object at the first location. After the feature is machined at the first location the power of the laser beam is readjusted to the first power range, and the first-power-range laser radiation is delivered to a second location on the object. If the detector arrangement determines that the first-power-range radiation is not focused on the object, the focal length of the optical system is varied until the detector arrangement determines that the first-power-range radiation is focused on the object. After the detector arrangement determines that the first power-level-laser radiation is focused on the object, the power of the laser radiation is adjusted to the second power range, and material is removed from the object using the second-power-range laser radiation until a feature is machined in the object at the second location.

In another aspect of the invention, each of the features has a predetermined depth, and the focal length of the optical system is varied by moving one or more of the optical elements of the optical system. The material-removing operation for machining a feature includes removing material from the object with laser radiation power adjusted into the second power range, then, with the laser radiation adjusted into the first power range, moving the one or more optical elements to vary the focal length of the optical system until the detector arrangement determines that the first-power-range radiation is focused on the object. The instant depth of the feature being machined is determined from the optical-element movement and compared with the predetermined depth. If the instant depth is less than the predetermined depth, the material removal and depth determining steps are repeated until the instant depth is about equal to the predetermined depth.

In a preferred embodiment of the apparatus, the detector arrangement includes an optical arrangement for dividing the reflected portion of the laser radiation into first and second parts. All of the first part of the reflected radiation is directed onto a first detector to provide a first electronic signal. The second part of the reflected radiation is directed through a focusing lens onto a pinhole aperture and a second detector is located behind the pinhole aperture to receive a portion of the second part of the reflected radiation transmitted through the pinhole aperture, thereby providing a second electronic signal. The pinhole aperture is located in a position with respect to the focusing lens and the optical system is arranged such that when laser radiation is focused on the object, the ratio of the second electronic signal to the first electronic signal has a maximum value.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain the principles of the present invention.

FIG. 1 schematically illustrates one preferred embodiment of laser engraving apparatus in accordance with the present invention including a laser providing laser radiation and an optical system for directing the laser radiation to an object to be engraved, the optical system having a scanning arrangement for directing laser radiation to from one location to another on the object to be engraved.

FIG. 2 is a block diagram schematically illustrating electronic components and their interconnection in an electronic controller for controlling the apparatus of FIG. 1.

FIG. 3 is a timing diagram schematically illustrating the interrelationship of electronic signals in the controller of FIG. 2.

FIG. 4 schematically illustrates another preferred embodiment of laser engraving apparatus in accordance with the present invention similar to the apparatus of FIG. 1 but wherein the optical system does not include the scanning arrangement and laser radiation is delivered from one location to another on the object to be engraved by moving the object from one position to another with respect to the optical system.

### DETAILED DESCRIPTION OF THE INVENTION

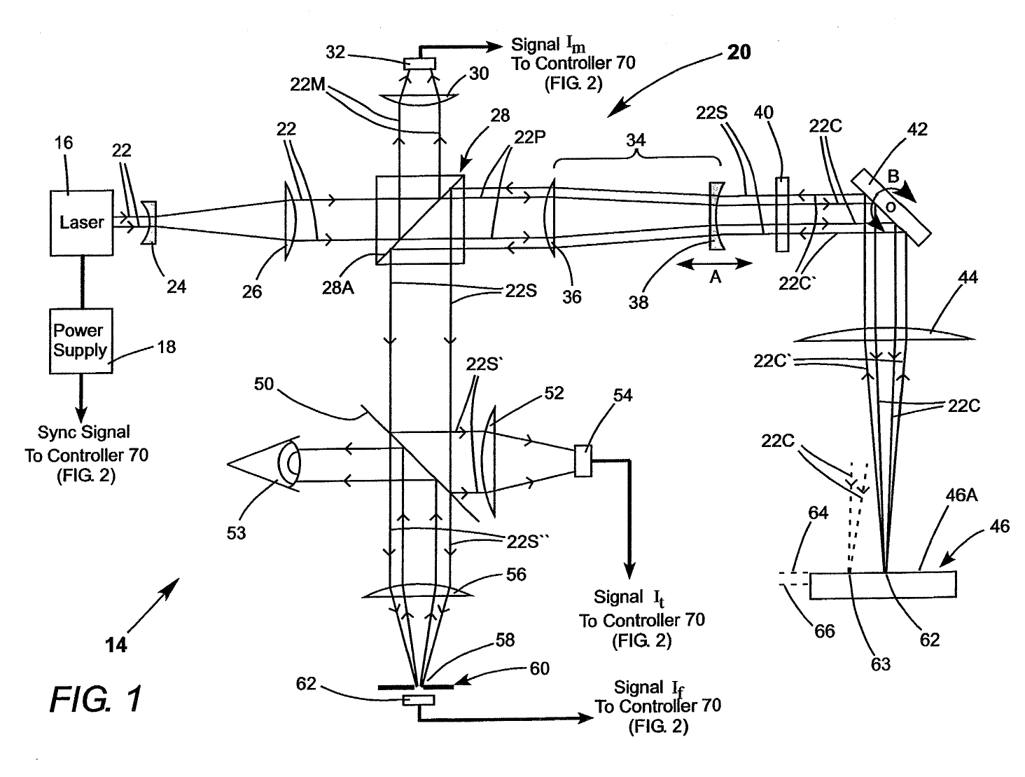

Referring now to the drawings, wherein like features are designated by like reference numerals, FIG. 1 schematically illustrates a preferred embodiment of laser engraving apparatus 14 in accordance with the present invention. Apparatus 14 includes a laser 16, a laser power supply 18, and an optical system 20. A beam of laser radiation 22 from laser 18 is expanded and collimated by passing the beam through a negative lens 24 and then through a positive lens 26. The expanded collimated beam is passed through a polarizing beamsplitter 28. On passing through polarizing beamsplitter 28 a relatively small portion, for example, about one percent is reflected as a beam 22M from reflecting face 28A of the polarizing beamsplitter and focused by a lens 30 onto a detector 32. The detected beam portion is represented by a signal Iₘ, which is used by electronic circuitry in a controller 70, described in detail further hereinbelow, for providing a measure of power in beam 22.

A plane polarized beam 22P exits polarizing beamsplitter 28 and is passed through a lens group 34 including a fixed, positive lens element 36 and a negative lens element 38 that is movable with respect to lens element 36 as indicated by double arrow A. Varying the axial position of the lens element 38 varies the focus of the optical system 20.

It is preferable that laser radiation from laser 16 is plane polarized. This will typically be the case for most solid-state lasers including frequency-converted lasers. Typically, commercially available polarizing beam splitters have sufficient stress birefringence that sufficient radiation will be reflected from the polarizing beamsplitter to provide beam 22M.

If laser radiation from laser 16 is not plane polarized, it will be polarized by polarizing beamsplitter 28. In this case, about 50 percent of the laser radiation will be reflected in beam 22M and some attenuation of the beam may be required to avoid overloading detector 32.

After exiting lens 34, beam 22P, still plane-polarized, passes through a quarter-wave plate 40 which causes the beam to become circularly polarized. The circularly polarized beam 22C is reflected by a galvanometer scan mirror 42 through a flat-field positive lens 44 which focuses the circularly polarized beam 22C onto a workpiece 46 to be engraved. Galvanometer scan mirror 42 is rotatable as indicated by arrows B and is one of two such mirrors used for scanning focused beam 22C over workpiece 46 in two different axes. As such galvanometer scanning mirror arrangements are well known in the art to which the present invention pertains, only one such mirror is shown in FIG. 1 for simplicity of illustration.

A portion of beam 22C focused on workpiece 46 is reflected as a beam 22C′, still circularly polarized, back through lens 44 to scan mirror 42. Scan mirror 42 directs circularly polarized beam 22C′ through quarter-wave plate 40. This causes the circularly polarized beam to become a plane polarized beam 22S, polarized in a plane perpendicular to the polarization plane of beam 22P. Beam 22S passes through lens group 34 into polarizing beamsplitter 28 and is reflected from face 28A of the polarizing beamsplitter onto beamsplitter 50.

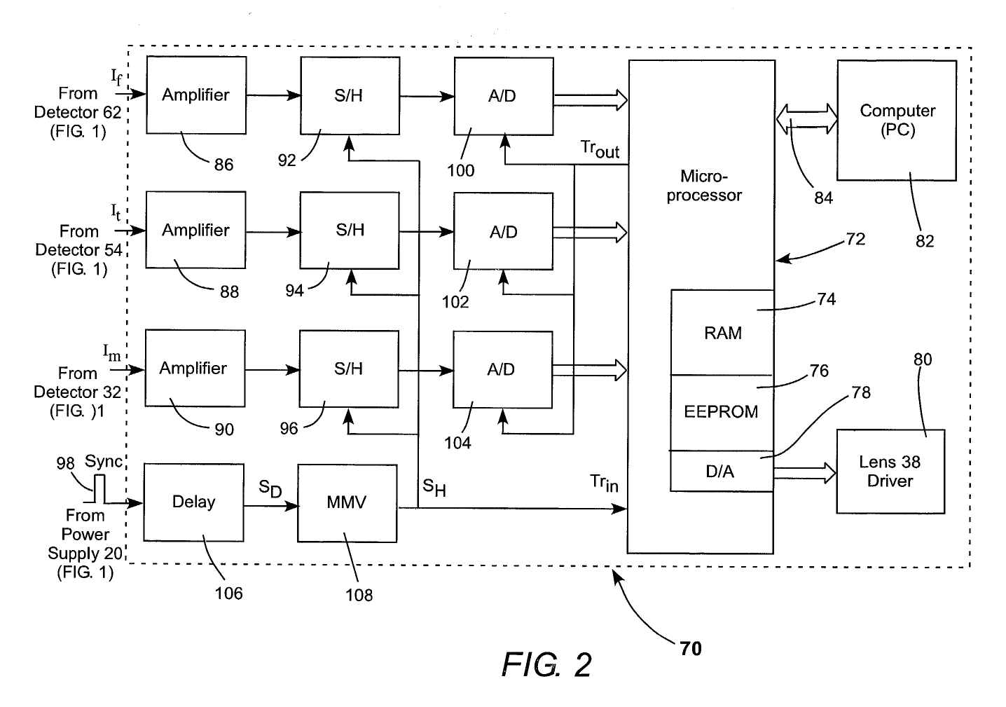

A portion 22S′ of beam 22S is reflected by beamsplitter 50 through a positive lens 52, which focuses beam 22S′ onto a detector 54. The power in this beam portion is represented by an electronic signal Iₜ from detector 54. Another portion 22S″ of beam 22S is transmitted through beamsplitter 50 and is focused by a lens 56 through a pinhole aperture 58 in a plate 60 onto a detector 62. The power in the portion of beam 22S″ that passes through pinhole 58 is represented by an electronic signal I_{f} from detector 60. The ratio of I_{f}:Iₜ provides a measure of the amount of beam 22S″ that passes through pinhole 58 relative to the total reflected power. Processing of signals I_{f} and Iₜ is performed by the above-discussed controller 70. One preferred arrangement of controller 70 is described in detail further hereinbelow with reference to FIG. 2.

It is particularly important that the amount of radiation passing through pinhole 58 is measured as the ratio I_{f}:Iₜ. This provides that the measurement is not significantly affected by changes in laser power or the reflectivity of a surface being engraved. It is also important that reflected beam 22C′ is collected by the same optical elements used to deliver beam 22C to the workpiece. This provides that small mounts of misalignment of these optical elements do not have any significant effect on the position of beam 22S″ on pinhole 58. Lenses 56 and pinhole 58 in plate 60 are adjusted in position such that beam 22S″ is focused onto pinhole 58 when beam 22C is focused on a surface that will reflect the beam back along its original path. At this position, the ratio I_{f}:Iₜ is maximized. Adjustment of the pinhole aperture can be observed by an observer's eye 53 via beamsplitter 50.

In one example of an engraving operation using apparatus 20, the position of lens 38 is adjusted such that beam 22C passes through lens 44 and is focused initially at a point 62 on upper surface 46A of workpiece 46 in a plane 64 coincident with the upper surface of the workpiece. As engraving proceeds at point 62, beam 22C penetrates into the workpiece and the part of the workpiece on which the beam is incident (the base of the feature being engraved) moves toward a plane 66 below plane 64, i.e., below the plane of initial focus. Correspondingly, the position of the focus of beam 22S″ moves and is no longer focused on pinhole 58. Because of this, the amount of light in beam 22S″ penetrating pinhole 58, and accordingly the ratio I_{f}:Iₜ is reduced. Lens 38 is moved until the ratio I_{f}:Iₜ is again maximized. When the ratio is maximized, beam 22C is again sharply focused on that portion of workpiece 64 instantly being engraved, i.e., on the base of the feature being engraved. Apparatus 20 can be calibrated such that the movement of lens 38 can be used as a measure of the movement of the position of the beam focus and correspondingly the depth of an engraved feature.

It should be noted here that lens group 34 represents one of the simplest of lens groups for changing the focus of optical system 20 and has only one moving lens. Those skilled in the art may devise more complex lens groups having more than two lenses in total, or more than one movable lens, without departing from the spirit and scope of the present invention.

In a complex lens group including more than one movable lens element, typically, all of the movable lens elements are moved synchronously by rotating a single sleeve including cam slots that move the movable lenses. Rotary movement of this sleeve can be effected by a shaft encoder or the like and interpreted as axial lens motion for maximizing the ratio I_{f}:Iₜ. Such a rotating sleeve and cam slot can be used, of course, to move a single lens such as lens 38. In such an arrangement the amount of rotation of the sleeve necessary to refocus beam 22C is used as a measure of the movement of one or a group of lens elements. One or more elements may also be moved by sliding a single sleeve linearly along the optical axis of the lens elements. In this description and in the claims appended hereto the terminology “moving one or more lens elements” is meant to include axially moving a single lens element or synchronously axially moving a group of elements with the motion of a single rotary or linear translation mechanism.

If, after engraving in one position on workpiece 46, beam 22 is scanned to another position on surface 46A of workpiece 46, it is most likely that beam 22C would not be at its sharpest focus at the new position. This being the case, lens 38 is moved again to maximize the ratio I_{f}:Iₜ before engraving commences. In this way, the beam can be brought to its sharpest focus even if workpiece 46 has an irregular surface, i.e., if points on surface 46A of workpiece 46 are not coplanar.

It should be noted here that while apparatus 16 is described as including a scanning mirror 42 for directing beam 22C to selected locations on workpiece 48 (such as location 63 indicated by dotted lines 22C), this should not be construed as limiting the present invention. Those skilled in the art to which the present invention pertains will recognize that moving beam 22C to different locations on the workpiece could be accomplished by providing a fixed turning mirror in place of mirror 42, thereby providing a fixed orientation of beam 22C, and by moving workpiece 46 relative to beam 22C, by means of a translation stage or the like.

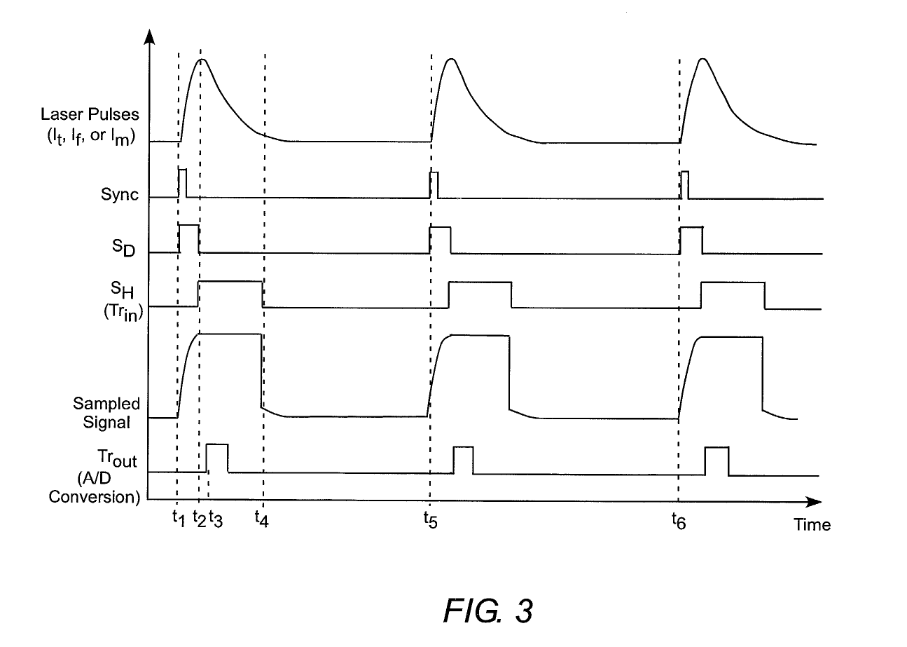

Referring now to FIGS. 2 and 3, with continuing reference to FIG. 1, electronic controller 70 includes a microprocessor 72 for processing signals I_{f}, Iₜ, and Iₘ and providing therefrom an analog output for moving lens 38 of zoom lens group 34 (see FIG. 1). One preferred microprocessor is a Model 68HC11 micro controller available from Motorola, Inc., of Phoenix, Ariz. Microprocessor 72 includes a random access memory (RAM) 74, which is used to store in-process variables and an electronically erasable programmable read only memory (EEPROM) 76 which is used to store operating software and related constants for operating the microprocessor and for processing signals. A digital to analog (D/A) converter 78 provides an analog signal for operating a servo driver 80 that is used to move lens 38 of variable-focus lens group 34. A personal computer 82 is in communication with microprocessor 72 via a port 84. Personal computer 82 is used for controlling laser 16 as well as for other functions discussed further hereinbelow.

In a preferred embodiment of apparatus 16, laser 18 is a pulsed laser and radiation in beam 22 is in the form of a sequence of pulses of laser radiation. Accordingly, controller 70 is arranged to process signals I_{f}, Iₜ, and Iₘ in the form of such pulses. Pulse signals I_{f}, Iₜ, and Iₘ from detectors 62, 54, and 32, respectively, are first amplified by amplifiers 86, 88, and 90, respectively. The output of amplifiers 86, 88, and 90 is connected to sample and hold (S/H) circuits 92, 94, and 96, respectively. The output of sample and hold (S/H) circuits 92, 94, and 96 is connected to analog to digital (A/D) converters 100, 102, and 104 respectively.

The amplified signals I_{f}, Iₜ, and Iₘ are sampled at their maximum value, digitized by the A/D circuits, and passed to microprocessor 72 for processing . A preferred method of effecting this sampling is set forth below. The method is applicable for any of the signals I_{f}, Iₜ and Iₘ.

The sampling method is synchronized by a synchronization signal (Sync). The synchronization signal is supplied from power supply 20 of laser 18 (see FIG. 1) and indicates that the laser has delivered a laser pulse at time t₁ (see FIG. 3). The synchronization signal triggers a delay circuit 106 (see FIG. 2). In response to the triggering, circuit 106 generates a signal S_{D} (see FIG. 3,) the falling edge of which, at time t₂, coincides with the time at which the laser pulse has a maximum value. This falling edge of signal S_{D} triggers a monostable multivibrator (MMV) circuit 108 (see FIG. 2) that stretches the pulse in time, resulting in a hold signal S_{H} (see FIG. 3) that controls the sample and hold circuits 92, 94, and 96. During the time that signal S_{H} is applied to the sample and hold circuits, the sampled signal is held at the maximum value read by the sample and hold circuits at the leading edge of the S_{H} signal.

The S_{H} signal is also connected to a digital input port (not explicitly shown) of microprocessor 72. The rising edge of this signal, at time t₂, provides a signal Trᵢₙ (see FIG. 2) that prepares a program (software) stored in the microprocessor to accept from AID converters 100, 102, and 104, digital signals representative of signals I_{f}, Iₜ, and Iₘ, and to process those signals. After a small delay, within the hold time of signal S_{H} (at time t₃ in FIG. 3), the program generates a signal Trₒᵤₜ and that signal is delivered by microprocessor 72 to the A/D converters. On receipt of the signal by the converters, A/D conversion (digitization) is initiated for the amplified signals held in the S/H circuits. The digitized signals are delivered to the microprocessor for processing. At time t₄, and the end of the hold period of S/H circuits 92, 94, and 96, the S/H circuits are returned to their sample state. Subsequent pulses are similarly sampled beginning in FIG. 3 at times T₅ and T₆.

From the digitized values of I_{f}, Iₜ, and Iₘ, the microprocessor computes the value of the ratio I_{f}:Iₜ, which, as noted above, is the principle value used to control system 16 for maintaining the focus of the system at the base of a feature being machined. Motion of lens 38 to adjust the focus of the system is effectuated by a lens driver 80, which requires an analog signal. This signal is generated by microprocessor 72 via a digital to analog (D/A) converter 76 (see FIG. 2).

In one preferred sequence of operations for making an engraving of a predetermined depth at location on workpiece 46, the predetermined depth is stored in microprocessor 72. A plurality of pulses, each thereof having insufficient power to remove material from the workpiece is delivered to a selected engraving location on the workpiece. These pulses may be referred to as scanning pulses and apparatus 16 may be referred to as being in the depth-scan mode. During the delivery of these pulses, lens 38 is moved incrementally until the ratio I_{f}:Iₜ is at a maximum, indicating that beam 22C is focused on the surface of the workpiece.

When beam 22C has been focused, one or more laser pulses having a predetermined power sufficient to remove material from the workpiece is delivered to the engraving location. These pulses may be termed engraving pulses. The number of engraving pulses is selected, according to preprogrammed data on the removal depth of material as function of pulse power, to remove less than the predetermined depth of material from the workpiece. Following the delivery of the engraving pulses the ratio I_{f}:Iₜ is no longer at a maximum. Apparatus 16 is again set to the depth-scan mode and scanning pulses are delivered while incrementally moving lens 38 until the ratio I_{f}:Iₜ is again at a maximum. The amount of movement of the lens is interpreted as a current engraving depth and compared with the desired, predetermined engraving depth by microprocessor 72. Microprocessor 72 then decides if one or more additional engraving pulses must be delivered. If more engraving pulses are delivered, the above-discussed sequence of operations is repeated until the desired engraving depth has been reached. Once the desired engraving depth has been reached, beam 22C may be moved to a new location on the workpiece and the above-described sequence of operations repeated, beginning by moving lens 38 to maximize the ratio and focusing beam 22C at the new engraving location.

It is preferable that laser 18 be arranged such that the power output of the laser can be switched rapidly without a significant change in the beam quality of the laser. This provides that when beam 22C is focused in the depth scan mode, the beam will remain focused when the power is switched to the engraving or machining mode. One possible arrangement is to arrange laser 18 as a Q-switched continuously-optically-pumped, solid-state, pulsed laser with selectively variable pulse repetition rate, optical pumping power is held constant, and peak pulse power is varied by varying the pulse repetition rate in a manner such that the average power extracted from the solid-state gain-medium of the laser is essentially constant. This provides that thermal conditions in the solid-state gain medium and, accordingly, beam quality, remain essentially constant. Such a laser is described in detail in U.S. patent application No. 09/416,354 the complete disclosure of which is hereby incorporated by reference. In another arrangement of a Q-switched continuously-optically-pumped, solid-state, pulsed laser with selectively variable pulse-repetition rate optical pumping power is held constant and the laser resonator is arranged to deliver continuous wave (CW) radiation when pulses are not being delivered and between pulses when pulses are being delivered. Such a laser is described in detail in U.S. patent application No. 10/001,681 the complete disclosure of which is hereby incorporated by reference. Both of these pulsed laser arrangements are available in an Avia™ model laser, from Coherent® Inc. of Santa Clara, Calif.

Those skilled in the art will recognize that apparatus 16 is useful in machining a plurality of nominally identical features even if the depth of feature is not monitored during machining of the feature, for example, if factors such as careful control of laser pulse delivery and knowledge of machining characteristics of a material are relied on to predict how many pulses are required to provide a desired depth of each feature. If these factors are relied on for depth control, focusing beam 22C at an initial feature location and refocusing the beam at each other feature location can provide that the machining (focal) spot condition is essentially the same prior to machining each feature.

As noted above, the depth of removal of material per delivered engraving pulse from workpiece 46 is a function of the power in that engraving pulse. It is also a function, inter alia, of the material of the workpiece, the reflectivity of the surface of the workpiece being engraved, and the depth in any feature at which engraving is taking place. Because of this, it can be useful to monitor pulse power and reflectivity during an engraving operation as well as monitoring the engraving depth.

During an engraving operation, signal Iₘ provides a measure of laser pulse power and signal Iₜ provides a measure of the power of the fraction of the pulse power reflected from workpiece 46. The ratio Iₜ:Iₘ provides a measure of the reflectivity of the workpiece. The amount by which lens 38 must be moved to maximize the ratio I_{f}/Iₘ provides a measure of the engraving depth, as discussed above. Accordingly, microprocessor 72 can be programmed to monitor pulse power during an engraving operation and to compute actual engraving depth as a function of pulse power and reflectivity for the material of workpiece 46. This data can be used at an intermediate stage of an engraving operation to update any stored data on these functions. The updated data can then be used to more accurately compute how many pulses are required to complete a subsequent or final stage of the engraving operation.

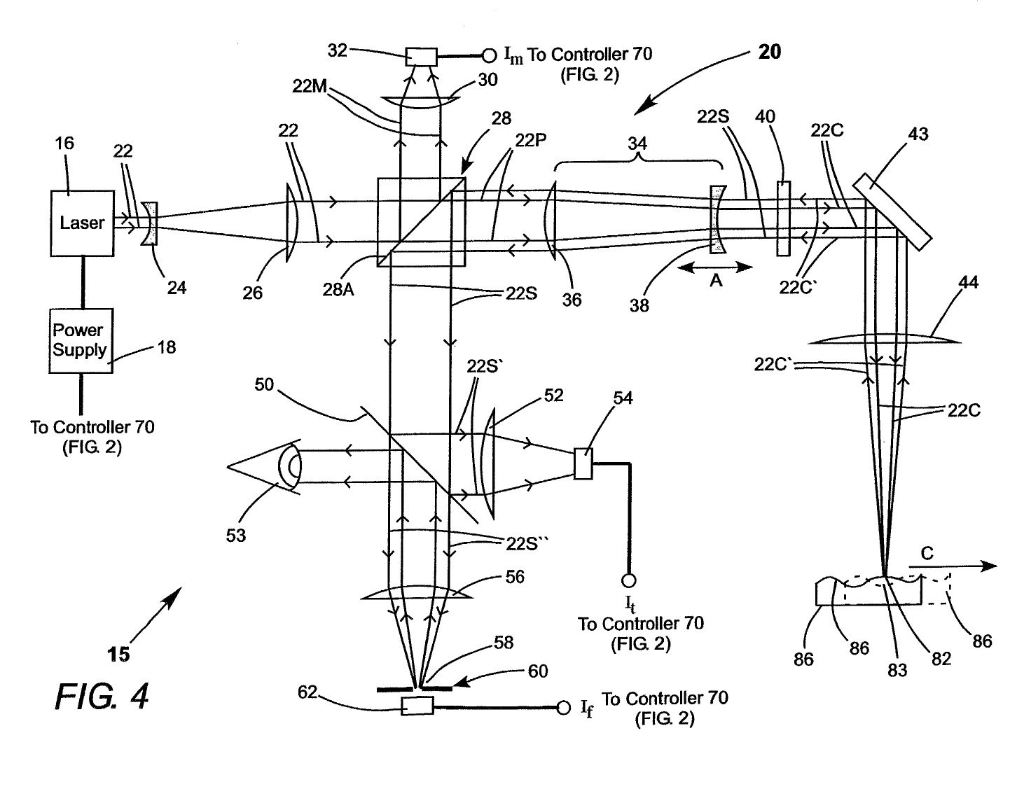

While apparatus 16 is described above as a laser engraving apparatus, the apparatus is useful as simply a measuring apparatus, for example, for determining the surface contour of an object such as workpiece 46. In a preferred surface contour determining operation, apparatus 14 is operated entirely in the depth scan mode, i.e., all laser radiation delivered by the apparatus has insufficient power to remove material from the workpiece. FIG. 4 schematically illustrates a preferred embodiment 15 of the present invention arranged for determining a surface contour. Apparatus 15 is similar to apparatus 14 of FIG. 1, but includes a fixed mirror 43 in place of scanning mirror 42 of apparatus 14. Beam 22C is moved to a starting location 82 on surface 86A of workpiece 86, and a plurality of scanning pulses is delivered to the starting location. During the delivery of these pulses, lens 38 is moved incrementally until the ratio I_{f}:Iₜ is at a maximum, indicating that beam 22C is focused on the surface of the workpiece. Workpiece 46 is then translated with respect to beam 22C, as indicated by the dotted outline of the workpiece. As a result of this, beam 22C is accordingly moved to a new location 83 on the surface of the workpiece. Lens 38 is moved if necessary, to maximize the ratio I_{f}:Iₜ and refocus beam 22C on the surface of the workpiece. The amount by which lens 38 must be moved to refocus beam 22C is interpreted as the difference in surface height between starting location 82 and the new location 83. The relocating and refocusing operations are repeated at a plurality of locations on the surface of the workpiece to determine a surface contour map of the surface.

While computing a surface contour map for a workpiece, it is possible to monitor the surface reflectivity of the workpiece at each surface-height measuring location, thereby providing a map of the variation of reflectivity over the surface.

The present invention is described above in terms of a preferred and other embodiments. The invention is not limited, however, by the embodiments described herein. Rather the invention is limited only by the claims appended hereto. For example, the detector arrangement need not necessarily be limited to the illustrated pinhole arrangement. Those skilled in the art would be aware of a variety of techniques for determining beam focus by monitoring the reflected beam. Some examples of focus measurement systems can be found in the following U.S. patents, each of which is incorporated herein by reference: U.S. Pat. Nos. 5,978,074; 5,910,842 and 6,052,478.

What is claimed is:

1. A method of laser machining a plurality of features in an object, comprising the steps of:
(a) providing a laser for delivering laser radiation, the power of which is adjustable;
(b) providing an optical system including a plurality of optical elements for delivering the laser radiation to the object, said optical system having a selectively variable focal length, said optical system and the object being arranged such that a portion of said laser beam delivered to the object is reflected from the object back into said optical system, and said optical system including a detector arrangement for determining from said reflected portion of said laser radiation whether or not said laser radiation is focused on the object;
(c) adjusting the power of said laser beam into to a first power range, the power in said first power range being insufficient to remove material from the object;
(d) delivering said first-power-range laser radiation to a first location on the object;
(e) using said detector arrangement, determining whether or not said first-power-range laser radiation is focused on the object;
(f) if in step (e) said detector arrangement determines that said first-power-range laser radiation is not focused on the object, varying the focal length of said optical system until said detector arrangement determines that said first-power-range radiation is focused on the object;
(g) after said first-power-range laser radiation is determined by the detector arrangement to be focused on the object, adjusting the power of said laser radiation to into a second power range, the power in said second power range being sufficient to remove material from the object;
(h) following step (g), removing material from the object using the second-power-range laser radiation until a feature is machined in the object;
(i) following step (h) adjusting the power of said laser radiation into said first power range, and delivering said first-power-range laser radiation to a second location on the object; and
(j) repeating steps (e) through (h).

2. The method of claim 1, wherein each of the features has a predetermined depth, wherein the focal length of the optical system is varied by moving one or more of said optical elements, and step (h) includes the sequential steps of: (k) with laser radiation power adjusted into said second power range, removing material from the object; (l) with said laser radiation adjusted into said first power range, moving said one or more optical elements to vary the focal length of said optical system until said detector arrangement determines that said first-power-range radiation is focused on the object; (n) determining from said optical element movement the instant depth of the feature being machined; (m) comparing said instant feature depth with the predetermined depth; and (o) if the instant depth is less than the predetermined depth, repeating steps (k) through (m) until the instant depth is about equal to the predetermined depth.

3. The method of claim 2, wherein said laser radiation is pulsed laser radiation.

4. Apparatus for delivering laser radiation an object, comprising:
a laser for providing the laser radiation and an optical system for delivering the laser radiation provided by the laser to the object;
said optical system being arranged to receive a portion of the laser radiation delivered to the object that is reflected from the object, and said optical system including a detector arrangement for determining from said reflected portion of the laser radiation whether or not the laser radiation delivered to the object is focused on the object;
said optical system having a plurality of lens elements, one or more thereof being axially movable cooperative with said detector arrangement for varying the focal length of said optical system until said detector arrangement determines that said laser radiation is focused on the object; and
said detector arrangement including an optical arrangement for dividing said reflected portion of said laser radiation into first and second portions, directing all of said first portion of said reflected radiation onto a first detector to provide a first electronic signal and directing said second portion of said reflected beam through a focusing lens onto a pinhole aperture, a second detector being located behind said pinhole aperture to receive a portion of said second portion of said reflected radiation transmitted through the pinhole aperture and provide a second electronic signal, said pinhole aperture being located in a position with respect to said focusing lens and said optical system being arranged such that when said laser radiation is focused on the object, the ratio of said second electronic signal to said first electronic signal has a maximum value.

5. A method for focusing laser radiation on an object, comprising the steps of:
(a) providing a variable focus optical system for focusing the laser radiation, said optical system including at least one or more lens elements movable for changing the position of the focus of the laser radiation relative to the optical system;
(b) directing the laser radiation through the optical system such that it is incident on the object;
(c) arranging the optical system and the object such that a portion of the laser radiation incident on the object is reflected from the object back through the variable focus lens along the path of the incident laser beam;
(d) after said reflected radiation has passed through said one or more movable lens elements, separating the path of the reflected laser radiation from the incident laser radiation;
(e) after the path of the reflected radiation has been separated from the path of the incident laser radiation, dividing the reflected radiation into first and second parts;
(f) directing said first part of said reflected radiation onto a first detector to provide a first electronic signal;
(g) directing said second part of said reflected radiation through a focusing lens onto a pinhole aperture;
(h) locating a second detector behind said pinhole aperture to receive a portion of said second part of said reflected radiation transmitted through the aperture and provide a second electronic signal, said pinhole aperture being located in a position with respect to said optical system and said optical system being arranged such that when said incident radiation is focused on the object the ratio of said second electronic signal to said first electronic signal has a maximum value; and
(i) moving said at least one or more movable lens elements such that said ratio of said second and first electronic signals is maximized, thereby focusing said laser radiation on the surface of the object.

6. The laser of claim 5, wherein the laser radiation from the laser is initially polarized in a first plane, the first-plane polarized radiation is circularly polarized by a polarization retarder before being incident on the object and remains circularly polarized immediately after being reflected from the object, the circularly-polarized reflected laser radiation is plane-polarized by said polarization retarder in a second-plane perpendicular to said first plane, and the second-plane polarized reflected radiation is separated from the path of the incident radiation by a polarizing beam splitter.

7. The laser of claim 6, wherein the initially-polarized laser radiation is transmitted through said polarizing beamsplitter with its polarization plane unchanged before being circularly polarized by said polarization retarder.

8. A method of laser machining a feature of a predetermined depth in an object, comprising the steps of:
(a) providing a laser for providing laser radiation, the power of which is adjustable;
(b) providing an optical system for delivering the laser radiation to the object, said optical system including one or more lens elements movable for varying the focal length thereof, said optical system and the object being arranged such that a portion of said laser radiation delivered to the object is reflected from the object back into said optical system, and said optical system including a detector arrangement for determining from said reflected portion of said laser radiation whether or not said laser radiation beam is focused on the object;
(c) adjusting the power of said laser beam into a first power range, the power in said first power range being insufficient to remove material from the object;
(d) delivering said first-power-range laser radiation to a location on the object at which the feature is to be machined;
(e) using said detector arrangement, determining whether or not said first-power-range laser radiation is focused on the object;
(f) if in step (e) said detector arrangement determines that said first-power-range laser radiation is not focused on the object, moving said one or more lens elements until said detector arrangement determines that said first- power-range radiation is focused on the object;
(g) after said first-power-range laser radiation is determined by the detector arrangement to be focused on the object, adjusting the power of said laser beam into a second power range, the power in said second power range being sufficient to remove material from the object;
(h) with said laser radiation in said second power range, removing material, from the object
(i) following step (h), adjusting the power of said laser beam into said first power range, and, if said detector arrangement determines that said first power laser radiation is not focused on the object, moving said one or more lens elements until said detector arrangement determines that said first-power-range radiation is focused on the object, determining from said lens motion the instant depth of the feature being machined, and comparing said instant depth with the predetermined depth; and
(j) if in step (i) said instant depth is less than the predetermined depth, repeating steps (g), (h), and (i) until said instant depth is about equal to said predetermined depth.

9. A method of determining a surface contour of a surface of an object, comprising the steps of:
(a) providing laser radiation;
(b) providing a variable focal length optical system for focusing the laser radiation on the surface of the object, said optical system including at least one or more lens elements movable for varying the focal length of the optical system, and said optical system including a detector arrangement for determining from a portion of said laser radiation reflected from the surface of the object whether or not the laser radiation is focused on the object;
(c) directing the laser radiation through said optical system such that it is incident on the surface of the object at a first location thereon, and focusing the laser radiation on the surface;
(d) following step (c) sequentially locating the laser radiation on the surface of the object at a plurality of different locations, and, at each of said plurality of different locations using the detector arrangement to determine, whether or not the laser radiation is focused on the surface of the object, and, if the detector arrangement determines that the radiation is not in focus, moving said one or more lens elements until the detector arrangement determines that the laser radiation is in focus; and
(e) determining from the amount of lens element movement needed to focus the laser radiation at each of said plurality of other locations the difference in surface height of said locations relative to said first location.
